(19) United States
(12) Patent Application Publication
(10) Pub. No.: US 2014/0317202 A1
(43) Pub. Date: Oct. 23, 2014

(54) SYSTEM AND METHOD FOR REQUESTING AND SENDING AUDIO, VIDEO, STILL PICTURES, AND TEXT FROM A SPECIFIED LOCATION

(71) Applicant: Tim Baldwin, Chandler, AZ (US)

(72) Inventor: Tim Baldwin, Chandler, AZ (US)

(21) Appl. No.: 13/866,725

(22) Filed: Apr. 19, 2013

(51) Int. Cl. H04L 29/06

(52) U.S. Cl. CPC H04L 65/403
USPC 709/206; 709/204

(57) ABSTRACT

A method for requesting and viewing real time data comprising: selecting an entity to follow by a requesting user; sending a notification by the entity to the requesting user when the real time data will be sent; recording the real time data by the entity; sending the real time data to a host server; and transmitting the real time data to the requesting user.

### TECHNICAL FIELD

The present application generally relates to social network application/website, and more specifically, to a social network application/website that may allow users to request video, audio, and or photographic data at a specified location anywhere in the world by cooperation between internet users and mobile phone users, and various devices such as websites, telecommunication companies, base stations, global positioning systems, base station databases of global telecommunication companies and video mobile phones.

### BACKGROUND

Currently, in order to obtain real-time images from a specific location, several different systems/devices may be used. For example, a user may use a computer, smartphone, or other web enabled device to obtain live video feeds from webcams positioned at different locations. Alternatively, mobile phones may be used as a camera in a Satellite News Gathering (SNG) system. Mobile phones with video conferencing features may also be used to obtain real-time images from a specific location. Also, programs like Windows Live, Google Earth and the like may also be used to obtain real-time images from a specific location. Web-based remote monitoring and control system used by security companies, or remote multi-robot monitoring and control system based on web services used by security companies are some other alternatives.

However, each of the above systems/devices has its own shortcomings. For example, webcams may not be located at a location a person wishes to view. While using the mobile phone in the Satellite News Gathering (SNG) system and the mobile phone in video conferencing, the user has to know the person and his/her phone number so as to seek assistance from him/her. Furthermore, he person may be not around the place the user intends to view. When using Windows Live the user needs to get the person's network address. Also, the person may be not around the place the user intends to view. In Google Earth, the database is too large and too slow so data update is difficult to get real-time images. Furthermore, the satellite is far away from the earth's surface so that the resolution of the lens is insufficient causing the image is unclear and static. With regards to security companies that use web-based remote monitoring and control system to get real-time images, these images are not available to most people. In practice, only the people related to the place being monitored are allowed to view these real-time images. Also, similar to webcams, only the place arranged with the monitoring and control system can be seen and there is no interaction.

Therefore, it would be desirable to provide a system and method that overcomes the above.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a method for requesting and viewing real time data is disclosed. The method for requesting and viewing real time data comprises: selecting an entity to follow by a requesting user; sending a notification by the entity to the requesting user when the real time data will be sent; recording the real time data by the entity; sending the real time data to a host server; and transmitting the real time data to the requesting user.

In accordance with another aspect of the present application, a computer-implemented method for requesting and viewing real time data is disclosed. The computer-implemented method for requesting and viewing real time data comprises: selecting an entity to follow by a requesting user; sending a notification by the entity to the requesting user when the real time data will be sent, wherein sending a notification further comprises sending one of an email, a text or the like to the requesting user; recording the real time data by the entity; sending the real time data to a host server; transmitting the real time data to the requesting user; transferring the real time data to a display to view the real time date; and viewing the real time video by the requesting user.

The features, functions, and advantages may be achieved independently in various embodiments of the disclosure or may be combined in yet other embodiments.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is a simplified block diagram showing a system using the social website/application of the present invention;

FIG. 2 is a simplified block diagram showing one of the electronic devices used in the system of FIG. 1;

FIG. 3 is a simplified block diagram showing one of the electronic devices used in the system of FIG. 1;

FIG. 4 is a settings screen of the social website/application of the present invention; and

FIG. 5 is a search screen of the social website/application of the present invention;

FIG. 6 is a map screen shot of the social website/application of the present invention;

FIG. 7 is a trending screen shot of the social website/application of the present invention;

FIG. 8 is an information screen of the social website/application of the present invention;

FIG. 9 is a request screen shot of the social website/application of the present invention;

FIG. 10 is an inbox screen shot of the social website/application of the present invention;

FIG. 11 is a location screen of the social website/application of the present invention;

FIG. 12 is a deal screen of the social website/application of the present invention;

FIG. 13 is a login screen shot for another embodiment of the present invention for sending real time video, audio, and or photographic data to a group of followers;

FIG. 14 is an account creating screen for the embodiment of FIG. 13;

FIG. 15 is a screen shot for editing account information for the embodiment of FIG. 13;

FIG. 16 is a screen shot for creating a group for the embodiment of FIG. 13;

FIG. 17 is a screen shot for adding a member to a group for the embodiment of FIG. 13;

FIG. 18 is a screen shot for adding a friend for the embodiment of FIG. 13;

FIG. 19 is a screen shot for sending live streaming videos for the embodiment of FIG. 13;

FIG. 20 is a screen shot for viewing live streaming videos for the embodiment of FIG. 13;

FIG. 21 is a screen shot for showing what live streaming videos are showing for the embodiment of FIG. 13;

FIG. 22 is a screen shot for favorite live streaming videos are showing for the embodiment of FIG. 13;

FIG. 23 is a screen shot for setting up live streaming videos for the embodiment of FIG. 13;

FIG. 24 is a countdown screen for showing the live streaming videos for the embodiment of FIG. 13;

FIG. 25 is a screen shot for recording the live streaming videos for the embodiment of FIG. 13;

FIG. 26 is a screen shot for ending and or pausing recording the live streaming videos for the embodiment of FIG. 13;

FIG. 27 is a screen shot of a group profile view for the embodiment of FIG. 13;

FIG. 28 is a screen shot of a personal profile view for the embodiment of FIG. 13;

FIG. 29 is a screen shot of editing a personal profile view for the embodiment of FIG. 13;

FIG. 30 is a screen shot of editing a group profile view for the embodiment of FIG. 13;

FIG. 31 a screen shot for changing an account for the embodiment shown in FIGS. 13; and

FIG. 32 a screen shot for account setting for the embodiment shown in FIG. 13

### DESCRIPTION OF THE APPLICATION

The description set forth below in connection with the appended drawings is intended as a description of presently preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

The present invention relates to a social network application/website (hereinafter application) that may allow users to request real time video, audio, and or photographic data (hereinafter data) at a specified location anywhere in the world such as a bar, restaurant, coffee shop, health club, beach, park, or the like. The listing is given as an example and should not be seen in a limiting manner. The social network application/website may be used to request the date any place of interest at any time. The application may be embedded into third party applications to allow the application to expand coverage.

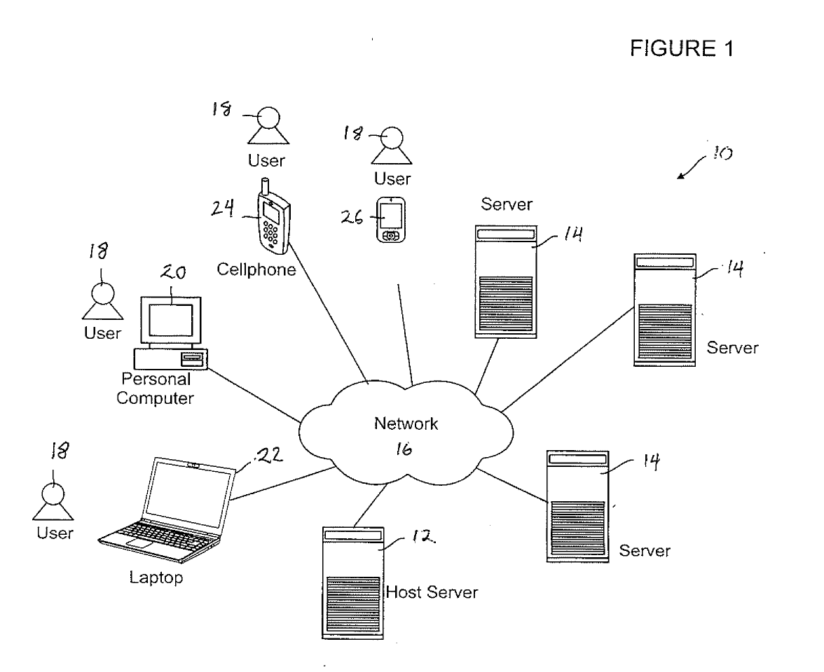

Referring to FIG. 1, a simplified block diagram showing a system 10 using the application of the present invention. The application may be loaded on one or more servers 12. The application may be embedded with third party applications hosted on other social website servers 14. This may allow third-party applications like Foursquare®; Yelp®; Twitter®; OpenTable®; and the like to use the present application regardless of the applications loaded on a electronic device of a user. The listing of the above is given as an example of third-party applications and should not be seen in a limiting scope.

The host server 12, the servers 14 hosting third party applications may communicate via a network 16. The network 16 may be a Local Area Network (LAN), an Internetwork (World Wide Web), or the like. The listing of the above is given as an example and should not be seen in a limiting manner.

The application may be accessed by one or more users 18. Each user may access the application using an electronic device having access to the network 16. The electronic devices may access the host server 12 via the network 16 by wired or wireless means. The electronic devices may be a desktop computer 20, a laptop computer 22, a cellular phone 24, a tablet 26 or the like. The listing of the above is given as an example and should not be seen in a limiting manner. Any electronic device which may communicate with the host server 12 via the network 16 may be used.

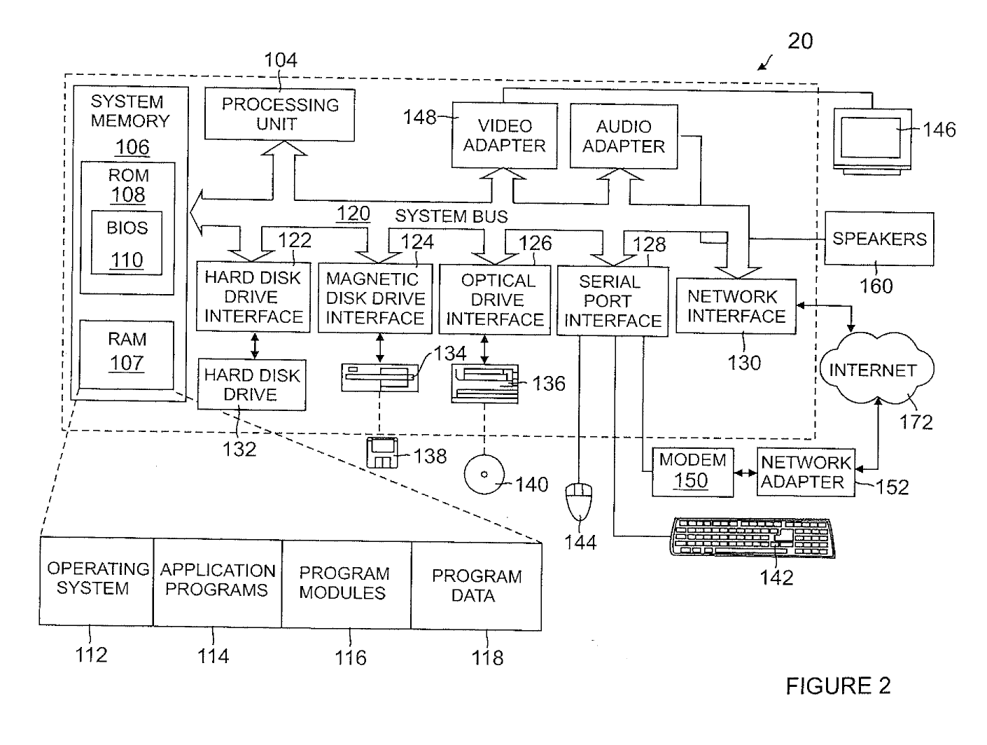

Referring to FIG. 2, an exemplary hardware and operating environment for implementing the application of the present application can include the desktop computer 20 as shown. It should be noted that the laptop computer 22 may have similar features. Typically, the processing can be performed on the desktop computer 20 as shown or, in the alternative, on the host server 12. Nonetheless, the components as described below within the desktop computer 20 can generally be found in each. The hardware can be represented in the form of the computer 20, which includes a processing unit 104, a system memory 106, and a system bus 120 that operatively couples various system components, including the system memory 106 to the processing unit 104. There can be only one or there can be more than one processing unit 104, such that the processor of the desktop computer 20 comprises a single central processing unit (CPU), or a plurality of processing units, commonly referred to as a parallel processing environment. The desktop computer 20 can be a conventional computer, a distributed computer, a web server, a file server, or any other type of computer.

The system bus 120 can be any of several types of bus structures including a memory bus or memory controller, a peripheral bus, a switched fabric, point-to-point connections,. and a local bus using any of a variety of bus architectures. The system memory 106 can also be referred to as simply the memory, and includes read only memory (ROM) 108 and random access memory (RAM) 107. A basic input/output system (BOIS) 110, containing the basic routines that help to transfer information between elements within the desktop computer 20, such as during start-up, is stored in ROM 108. The desktop computer 20 further includes a hard disk drive 132 for reading from and writing to a hard disk, not shown, a magnetic disk drive 134 for reading from or writing to a removable magnetic disk 138, and an optical disk drive 136 for reading from or writing to a removable optical disk 140 such as a CD ROM or other optical media.

The hard disk drive 132, magnetic disk drive 134, and optical disk drive 136 can be connected to the system bus 120 by a hard disk drive interface 122, a magnetic disk drive interface 124, and an optical disk drive interface 126, respectively. The drives and their associated computer-readable medium provide nonvolatile storage of computer-readable instructions; data structures, e.g., a catalog and a contextual-based index; program modules, e.g., a web service and an indexing robot; and other data for the computer 20. It should be appreciated by those skilled in the art that any type of computer-readable medium that can store data that is accessible by a computer, for example, magnetic cassettes, flash memory cards, digital video disks, RAM, and ROM, may be used in the exemplary operating environment.

A number of program modules can be stored on the hard disk 132, magnetic disk, optical disk 136, ROM 108, or RAM 107, including an operating system 112, one or more application programs 114, other program modules 116, and program data 118. A user can enter commands and information into the personal computer 102 through input devices such as a keyboard 142 and pointing device 144, for example, a mouse. Other input devices (not shown) can include, for example, a microphone, a joystick, a game pad, a tablet, a touch screen device, a satellite dish, a scanner, a facsimile machine, and a video camera. These and other input devices are often connected to the processing unit 104 through a serial port interface 128 that is coupled to the system bus 120, but can be connected by other interfaces, such as a parallel port, game port or a universal serial bus (USB).

A monitor 146 or other type of display device can also be connected to the system bus 120 via an interface, such as a video adapter 148. In addition to the monitor 146, computers typically include other peripheral output devices, such as a printer and speakers 160. These and other output devices are often connected to the processing unit 104 through the serial port interface 128 that is coupled to the system bus 120, but can be connected by other interfaces, such as a parallel port, game port, or a universal serial bus (USB).

The desktop computer 20 can operate in a networked environment using logical connections to one or more remote computers. These logical connections can be achieved by a communication device coupled to or integral with the desktop computer 20; the application is not limited to a particular type of communications device. The remote computer can be another computer, a server, a router, a network personal computer, a client, a peer device, or other common network node, and typically includes many or all of the elements described above relative to the desktop computer 20, although only a memory storage device has been illustrated in FIG. 2. The desktop computer 20 can be logically connected to the internet 172. The logical connections can include a local area network (LAN), wide area network (WAN), personal area network (PAN), campus area network (CAN), metropolitan area network (MAN), or global area network (GAN). Such networking environments are commonplace in office networks, enterprise-wide computer networks, intranets and the Internet, which are all types of networks.

When used in a LAN environment, the desktop computer 20 can be connected to the local network through a network interface or adapter 130, which is one type of communication device. When used in a WAN environment, the computer 102 typically includes a modem 150, a network adapter 152, or any other type of communications device for establishing communications over the wide area network. The modem 150, which can be internal or external, is connected to the system bus 120 via the serial port interface 128. In a networked environment, program modules depicted relative to the desktop computer 20, or portions thereof, can be stored in a remote memory storage device. It is appreciated that the network connections shown are exemplary and other means of and communications devices for establishing a communications link between the computers can be used.

The technology described herein can be implemented as logical operations and/or modules in one or more systems. The logical operations can be implemented as a sequence of processor-implemented steps executing in one or more computer systems and as interconnected machine or circuit modules within one or more computer systems. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. Furthermore, it should be understood that logical operations can be performed in any order, unless explicitly claimed otherwise or a specific order is inherently necessitated by the claim language.

The desktop computer 20, as described above, was exemplary and should not be construed as limiting. The desktop computer 20 typically encompasses many types of other devices. Such devices may include a cell phone, personal digital assistant (PDA), stationary personal computer, IPTV remote control, web tablet, laptop computer, pocket PC, a television set capable of receiving IP based video services and mobile IP device, etc

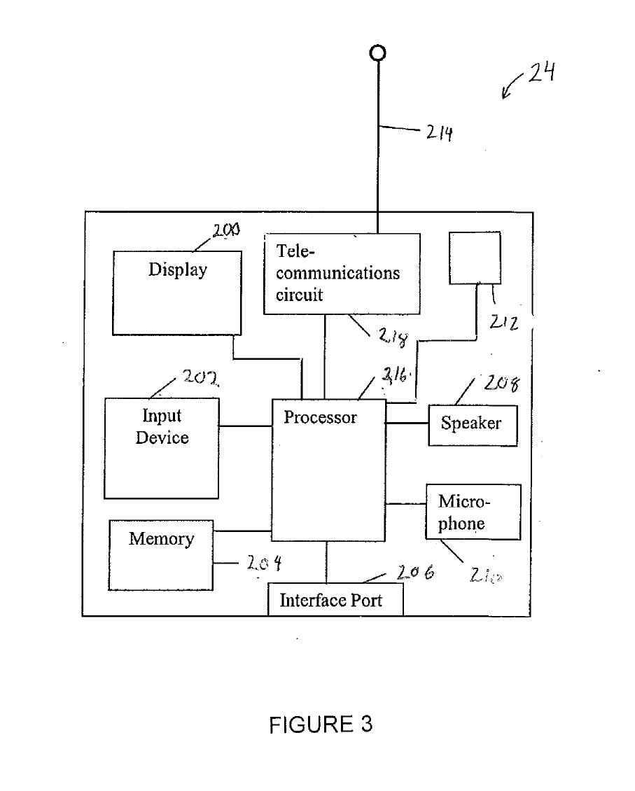

Referring to FIG. 3, a simplified fictional block diagram of the cellular phone 24 is shown. The cellular phone 24 includes a display 200, at least one input device 202, memory 204, an interface port 206, a speaker 208, a microphone 210, a picture camera/video camera 212, and an antenna 214, all in circuit communications with at least one processor 216. Typically the display 200 is a liquid crystal display (LCD), however the display can be one or more of virtually any type of display, e.g., textual displays (such as n character by m line LCD or plasma displays, etc.), binary displays (such as LEDs, lamps, etc.), graphical displays (such as LCD displays that can display text and bar graphs and the like), etc.

The input device 210 can be any number of different inputs devices, including, but not limited to, one or more keys, a thumb wheel that permits a user to quickly scroll through a list of options, a four-direction cursor controller, a touch screen, a voice activated input, or any combination thereof. The memory 204 permits the user to store information, such as names and phone numbers, that do not get erased when the battery is removed from the cellular phone 24 for short periods of time, and permits the cellular phone service provider to update the programming as required. The cellular phone 24 has a telecommunications circuit 218 for establishing a connection to a cellular tower and transmitting and receiving data via the antenna 214. The speaker 208 and the microphone 210 are shown connected to the processor 216, however, the speaker 208 and microphone 210 may be connected to the telecommunications circuit 218. Data representing a human voice is transmitted to the speaker 208 by either the telecommunications circuit 218 or the processor 216, wherein the data is communicated to a user in human hearable form. The microphone 210 transmits data representing a human voice to either the telecommunications circuit 218 or the processor 216. Data representing a human voice is transmitted/received by the telecommunications circuit 218 to/from a remote location.

The cellular phone has an interface port 206. The interface port 206 may permit the user to connect the cellular phone 24 to other devices, such as a computer, in order to perform functions such as downloading new programming information, downloading sound bites, and connecting other peripheral devices. As discussed above, the interface port 220 can be any communications port.

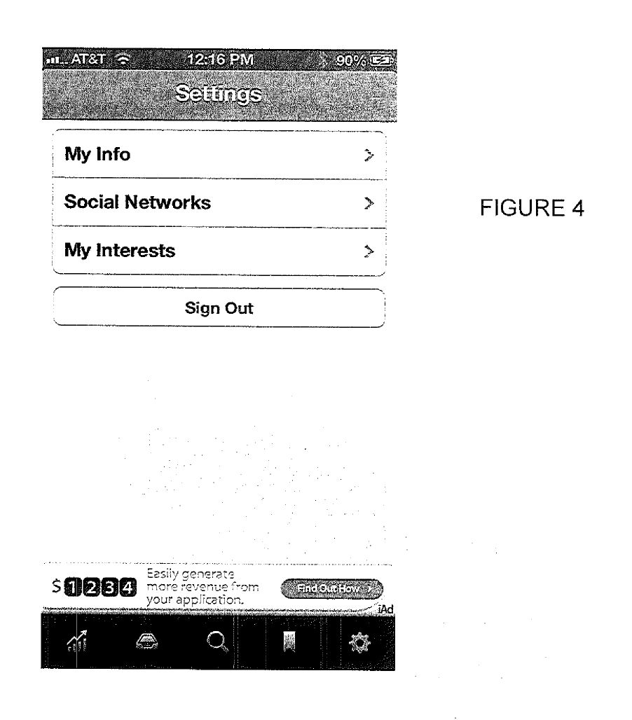

Referring now to the Figures, operation of the application will be disclosed. Each user 18 may need to register in order to use the application. Each user 18 may access a website hosted by the host server 12 via the network 16 via an electronic device by wired or wireless means. Alternatively, each user 18 may download the application to a mobile device and register via the application. Registering may include, but is not limited to: selecting a user name, password, and the like. The above listing is given as an example and should not be seen in a limiting manner. Once a user has registered, the user may be sent to a settings page as shown in FIG. 4. The setting page may allow a user to set user preferences. For example, the user may be allowed to set user interest, social networks that the user may use, and other user information. The above listing is given as an example and should not be seen in a limiting manner.

Once a user 18 has registered, the user 18 may be allowed to use the application/website (hereinafter application). As stated above, the application allows users 18 to request real time video, audio, and or photographic data (hereinafter data) at a specified location anywhere in the world such as a bar, restaurant, coffee shop, health club, beach, park, or the like. Other users 18 at the requested location may then send the request data from the location to the requesting user 18.

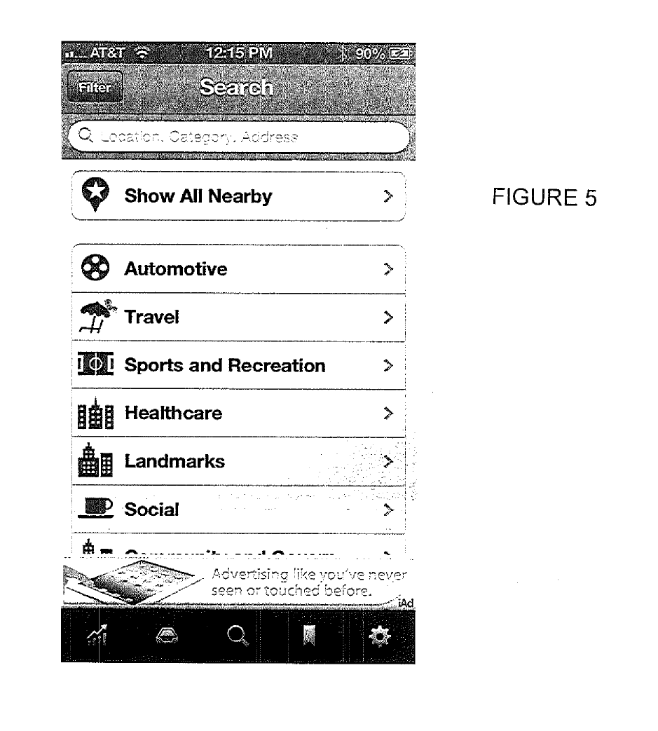

In operation, a user 18 may access the application via a mobile device or other electronic device. After accessing the application and signing in, a request for the data may be made by a user 18 (the Requestor). The Requestor may request the data from a population of users possessing enabled mobile devices (Requestees) at or around a specific location selected by the Requestor. The request process is as follows. The Requestor searches and selects a location using a mobile device with the application or by logging into the website via a mobile device or a desktop computer 20. The Requestor may be sent to a search page as shown in FIG. 5. The Requestor may select a location in multiple ways. For example, the Requestor may enter information in a search bar on the search page including but not limited to an address, keywords, a name of a place of interest, longitude/latitude data and the like.

The search page may further have one or more tabs. As shown in FIG. 5, the search page may have tabs showing different categories of locations/places of interest. For example, there may be a tab for nearby automotive related places, travel, sport and recreations places, healthcare places, local landmarks, etc. The above listing is given as an example and should not be seen in a limiting manner, When a tab is selected, a list of places may be displayed, a map of the locations may be displayed, or the like.

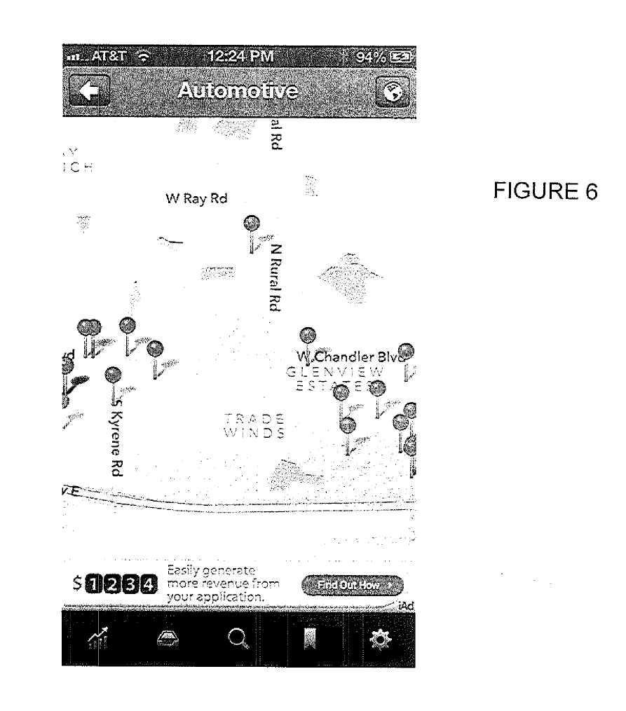

An example of the map may be shown in FIG. 6. If the automotive tab is selected, the Requestor may be sent to a map as shown in FIG. 6. The map may show different locations of automotive places. The Requestor may then select one of the pins on the map. Alternatively, a blank map may be displayed. The map may be a street map, a satellite image map or the like. The Requestor may then select a point on a digital map.

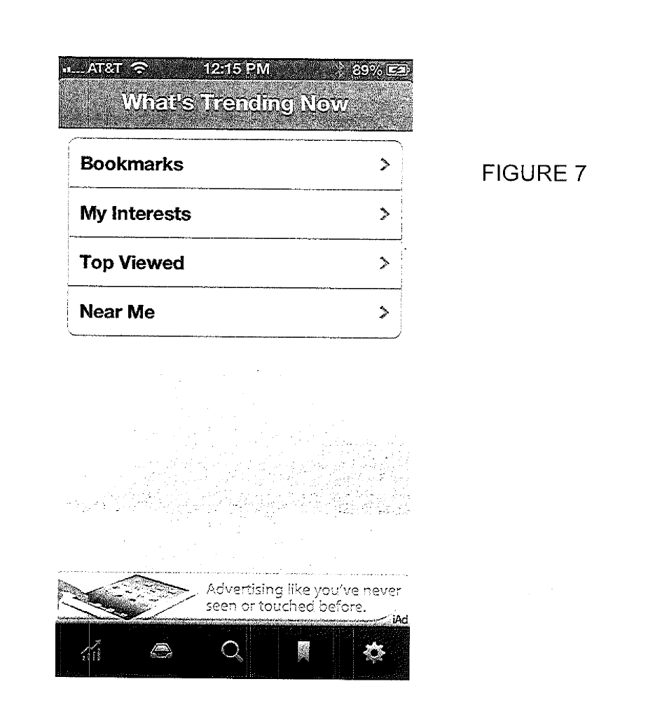

Another way of performing a search is to go to a trending page as shown in FIG. 7. The trending page may have one or more tabs. For example, the tabs may show different locations the Requestor may have bookmarked, different places of interest, top viewed places, nearby places and the like. When a tab is selected, a list of places may be displayed, a map of the locations may be displayed, or the like.

In operation, the Requestor may want to see what is currently happening at a particular night club. The Requestor may then enter the address of the night club, enter a keyword search if the user is unsure of the name of the night club, enter name search, enter a longitude/latitude, or searching by selecting a point on the digital map.

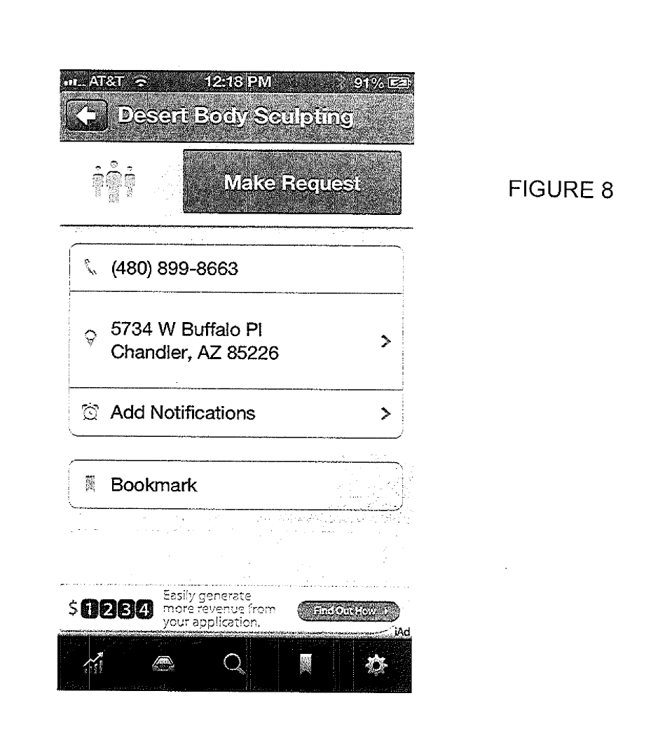

Once a location has been selected, an information page of the local selected may appear. An example of the information page may be seen in FIG. 8. If the Requestor would like to make a request for data, the Requestor may select the Make Request button on the information page. The Requestor may then be sent to a Make A Request Page. The Requestor selects a tab to pick which type of media is being requested. The media options may be live streaming video, video clips, photographs, or the like. The above listing is given as an example and should not be seen in a limiting manner. Thus, in the above example, if the user would like to see what is currently happening at the night club, the Requestor may want to select live streaming video as the data to be sent.

The Requestor can optionally include a custom text message or a system default text message with the request that is included with the request for media. A text message may be a specific instruction such as where at the specified location the Requestee should acquire the media, what specifically the Requestor is asking for media, and the like. Locations can have one or more default text messages presented by the system that vary by the location and/or the type of location selected (e.g. coffee shop, fitness center, hospital, etc.). The Requestor can optionally indicate a request for a text response in addition to or in lieu of a media response. The Requestor can optionally schedule the request for a future date and time and additionally schedule the request for recurrences such as daily, weekly, and monthly for example.

The Requestor may optionally selects a radius distance from the selected location in which to define an area for the system to locate enabled devices and qualify them as Requestee devices. This process is necessary as to not send requests to devices that are not within a reasonable proximity to a selected location. If the Requestor does not specify a radius distance, the system will default to a radius distance. For example, 100 yards by default.

The Requestor may also select a timeframe for how long the request should stay active. For example, the Requestor may desire media for the next 60 minutes. The system may have a default time value, 30 minutes for example. This feature is used to allow enough time for a Requestee to be present within the specified radius of the location whether or not a Requestee is present at the time of the initial request. This feature also allows enough time for a Requestee to respond to the request. The Requestor may then send the request.

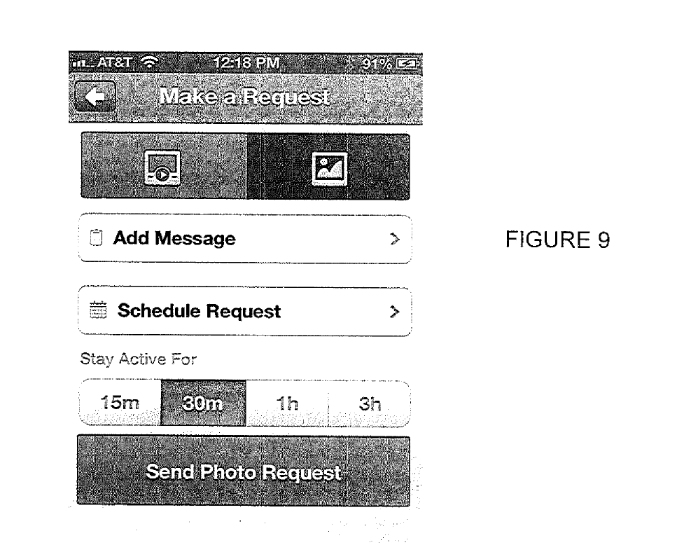

The application sends a message of the Request to the Requestor's application inbox (shown in FIG. 9) and get's organized under open requests. Alternatively, other notification means may be used to confirm the Request. For example, a text message, email or the like may be sent to the Requestor for confirmation.

The application determines which users are available to respond to a Request that are within the specified radial distance of the requested location and sends each person a notification message to their enabled devices. The application may apply rules to determine which users receive notifications if there are more users with enabled devices that exceed a maximum threshold determined by the application. For example, the application may select the top 20 enabled users that have historically responded the most to previous requests to send the Request notification to instead of the entire population of enabled users that are within the requested radial distance of the location. Another rule may be that the application notifies a select number of Requestees initially and if they do not respond within a certain period of time such as 3 minutes, the application will notify another batch of Requestees and then the process repeats until the request has expired or a Requestee has responded. Rules may also be combined. The above listing of rules is given as examples and should not be seen in a limiting manner.

Requestees that receive a notification from the system may also receive a message in their applications inbox (similar to the inbox of the Requestor shown in FIG. 9) under Assigned Requests. The Requestee can select the Request message under this grouping to fulfill the request. It should be noted that alternative notification means may be employed to send notifications to the Requestees. For example text messages, emails or the like may be sent to the Requestees to notify the Requestee. The application may send a signal to vibrate the electronic device of the Requestee or send other sensory signals. The above listing is given as examples and should not be seen in a limiting scope. Other notification means may be used without departing from the spirit and scope of the present invention.

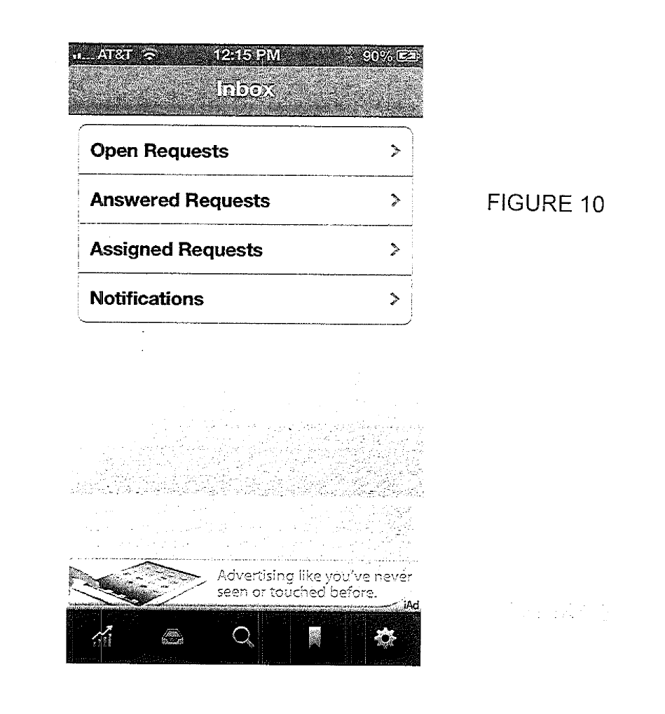

If a Requestee decides to respond to a request, the Requestee can either select the notification message which navigates the user to an enabled application or the Requestee can manually navigate to an enabled application. The Requestee may then respond to the Request. In accordance to one embodiment, the Requestee may select the Request message in the user's inbox in the application. If for example a photograph was requested, the Requestee would be navigated to a camera feature by selecting the request message. Likewise if live streaming video or a video clip was requested. Alternatively, if the Requestee selects the notification message, the Requestee may be sent to a page of the enabled application as shown in FIG. 10. The Requestee may then select the Photo Tab or Video Tab to take a picture or video. When the Requestee has completed capturing the requested media and/or text, the application will send the media and/or text to the host server 12 which will make the media and/or text available to the Requestee's application(s) and additionally the particular location's screens within all enabled applications.

When media is created for a location, any user viewing that location will be able to see the media regardless if the user made the original Request for the media. The media may expire and become inactive to where users will no longer be able to view the media after a set period of time such as 3 hours after media creation time.

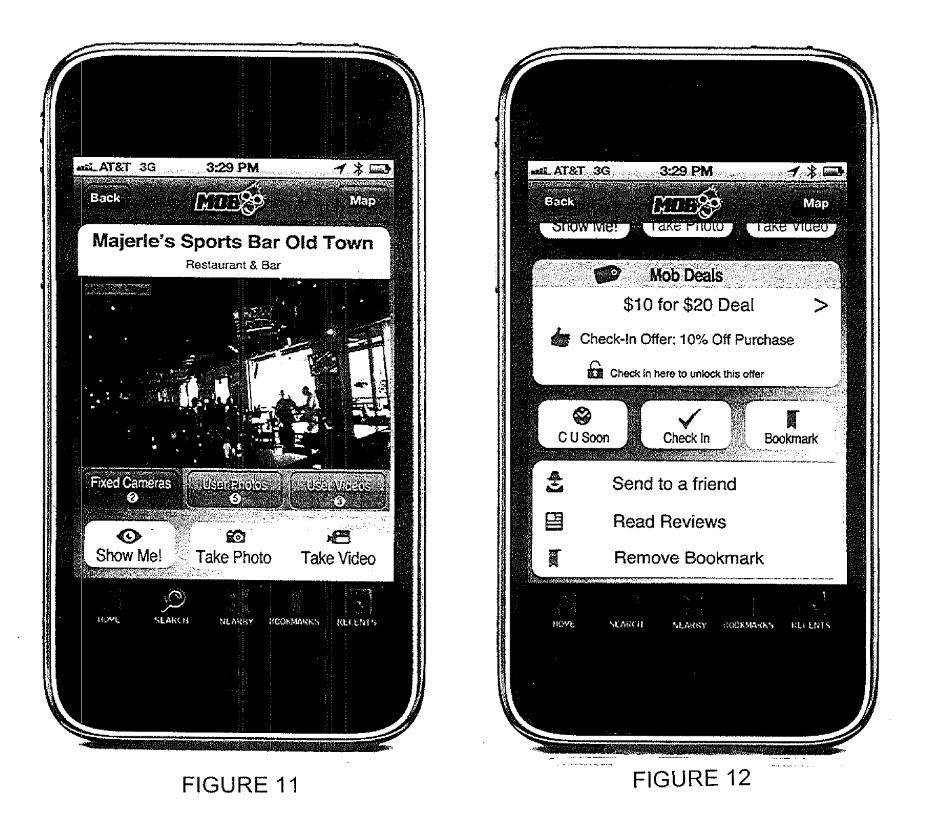

A message may be including in the media if messaging is associated with the particular requested location (See FIG. 11). For example, if a coffee shop is the requested location, the owner of the coffee shop may input one or more messages into the system to be included in the media delivery that will be associated with the location in enabled applications. The message may be an advertisement for that location.

Once the Requestee has completed capturing the requested media and/or text, the application will send a notification to the Requestor that the request has been fulfilled and additionally place a message in the Requestors inbox under Answered Requests so the Requestor can view the response at a future time. The requestor can select the notification message or the message in the inbox to navigate to the media. The Requestor has the option to either accept or reject the response media or text response from the Requestee.

If the Requestor rejects the response then the media is no longer associated with the specified location and a new Request is generated by the system. Requests that are not responded to for a fixed period of time such as 3 hours for example will become inactive in the system.

If multiple users receive a request and one of the users responds to the request, the others who attempt to respond to the request will be notified by the system that the request has already been fulfilled. The request message in those users inbox will also be regrouped to an inactive request group. All inbox messages will expire and be deleted from a user's inbox after a fixed period of time such as 3 hours.

### Location Monitoring Process

As stated above, the requestor may request the data from a population of users possessing enabled mobile devices (Requestees) at or around a specific location selected by the Requestor. The application may use geo-fencing. A user may become geo-fenced (identified within a distinct geographical area) as soon as the application launches and the user gives permission to and the user gives permission to activate an iOS Location Service. This enables the user to be tracked via GPS. iOS controls the activation of the GPS and provides callbacks to monitor the changes via the a Location Manager in the Core Location framework. A user is geo-fenced via his latitude & longitude center coordinate, and a variable radius in iOS. This geofence is also active while the application is running the background, so that the user's location/position is always up to date.

Once the user is geo-fenced, the geo-fenced location data is sent to the host server 12. Via a RESTful API which keeps a record of each user in the system. A user's location is constantly monitored. Any change in longitude/latitude of a user is sent to the host server 12. The host server 12 reverse geocodes the users location every time it is updated via the Factual Reverse Geocoder to determine where a user is within a variable amount of yards. The address that is a result of the reverse geocode comes firm the Factual Global Places database.

After the host server 12 reverse geocodes the latitude and longitude of the location of the user, the host server 12 then attempts to do a vicinity search to determine which users are nearby the requested location. In accordance with one embodiment, the vicinity search is done by using the Pythagorean Theorem for equl-rectangular approximation of a users latitude/longitude against a location's latitude/longitude. An alternative approximation of location between two points can be achieved by using a more accurate Haversine formula. The above methods are given as an example and should not be seen in a limiting manner. Other methods may be used without departing from the spirit and scope of the present invention.

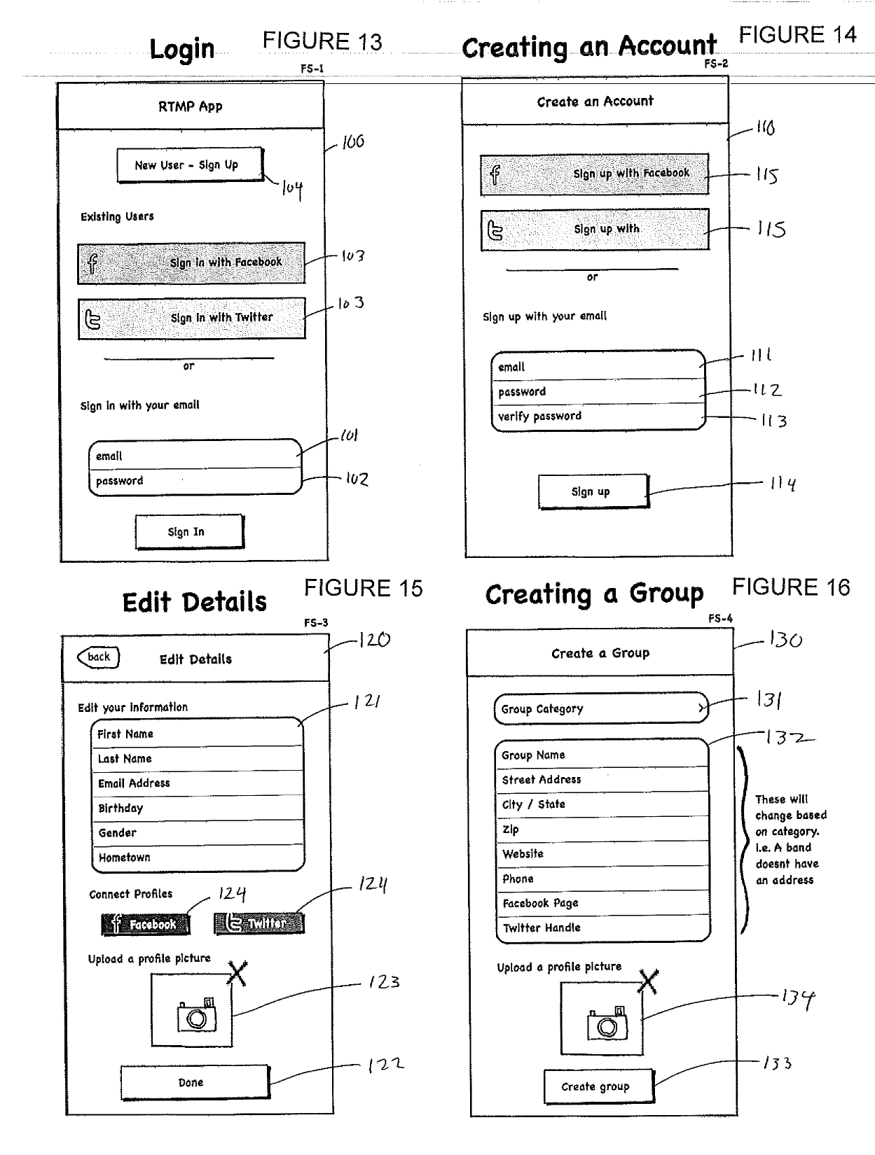

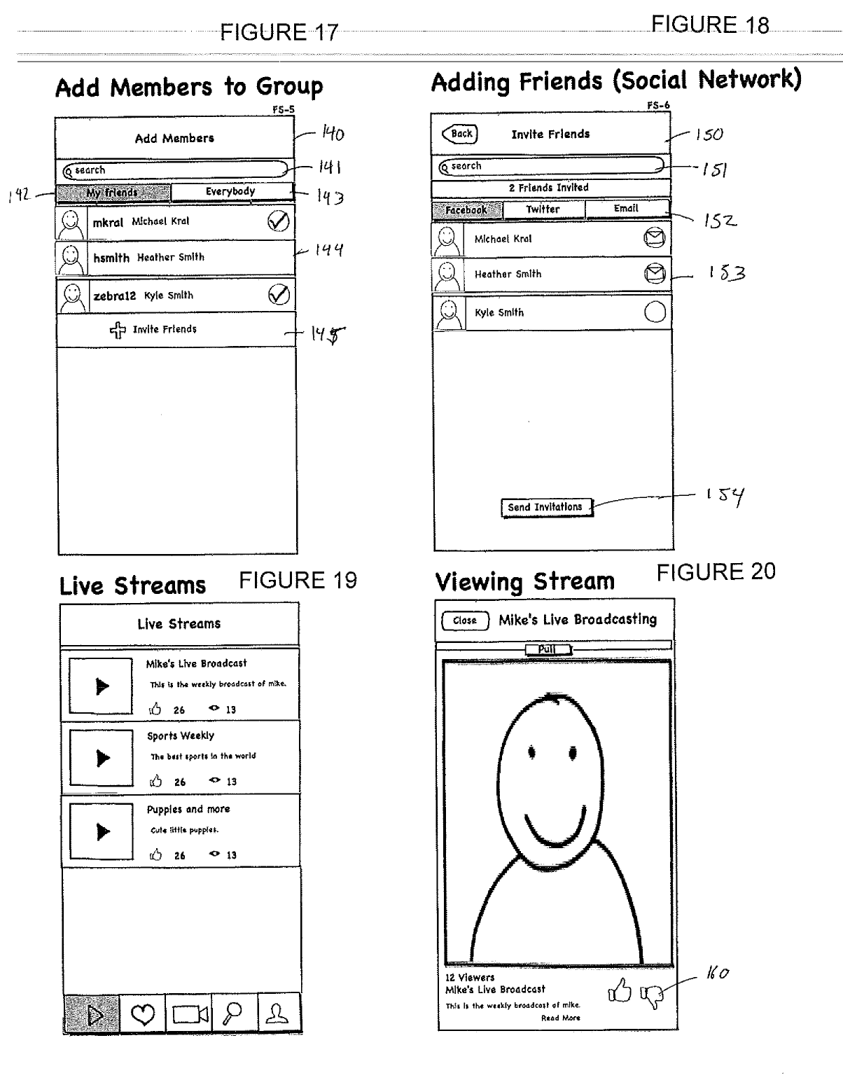

Referring now to FIGS. 13-32, another embodiment of the present invention will be disclosed. In this embodiment, the present invention relates to a social network application/website (hereinafter application) that may allow a person and or entity (hereinafter entity) to send real time video, audio, and or photographic data (hereinafter data) to a group of followers. This embodiment functions in a similar manner to that disclosed above. An entity (a person, a group of people like a music band, a business, etc.) may send video/audio from a cellular phone 24 (FIG. 1) within the application or any other video camera setup coupled to the application to an anonymous base of users that “follow” the entity. An entity can elect in the application to be followed by any anonymous user of the application. Users of the application and users of other applications (Facebook, Twitter, etc) enabled by the application can elect to follow entities within the application.

As shown in Figures, the user may be required to login via a login screen 100 (FIG. 13). The login screen 100 may have an area 101 to enter a user name/email and an area 102 to enter a password. Once this information has been entered, the user may login to the account. Alternatively, a user may use a user name and password associated with a social networking website to login to an account. Thus, the login screen 100 may have an area 103 to login to an account using a social networking website. If the user does not have an account, the login screen 100 may have an area 104 for new user sign-up. If the area 104 is pressed, the user may be sent to a Create An Account screen 110. The Create An Account Screen 110 may have an area 111 for entering a User Name/Email as well as an area 112 for entering a password. An area 113 may also be provided for verifying the password. Once a user name and password have been entered, the user may press a sign-up button 114 to register. Alternatively, the user may register by using a user name and password associated with a social networking website. Thus, the Create An Account screen 110 may have an area 115 to login to an account using a social networking website.

Once a user has registered, a user may be sent to an Edit Detail screen 120. The Edit Detail screen 120 may have an area 121 for entering personal identification information. For example, a user may have to enter a First name, a last name, an email address, birthday, gender, hometown, and the like. The above is given as an example and should not be seen in a limiting manner. Once this information has been entered, a user may press an enter button 122 to save the information. The user may further be able to add a profile picture by pressing a profile picture button 123 and uploading a profile picture. A user may be able to link a user's personal information associated with a social networking website by pressing a social networking website button 124.

A user may create a group by using a Creating A Group screen 130. The Creating A Group screen 130 may have a pull down menu 131 to allow the user to select a type of entity (a person, a group of people like a music band, a business, etc.). Once a type of entity is selected, the user will enter identification information about the entity in area 132. The type of information entered will be based on the type of entity selected. Once this information has been entered, a user may press an enter button 133 to save the information. The user may further be able to add a profile picture of the entity by pressing a profile picture button 134 and uploading a profile picture.

Once a group has been created, the group may add members as shown in screen 140. The add member screen 140 may have an area for searching specific friends 141. The add member screen 140 may have a tab 142 for selecting “My Friends Directory” or a tab 143 for selecting “All Contacts”. When a tab 142/143 is selected, a list of individuals is shown in area 144. The user may then select which individuals to invite to join the group. Once individuals are selected, the user may press button 145 to invite the individuals to join the group.

A group may add members via a social network screen 150. The social network screen 150 may have an area for searching specific friends 151. The social network screen 150 may have a tab 152 for selecting a specific social networking website. When a tab 152 is selected, a list of individuals is shown in area 153. The user may then select which individuals to invite to join the group. Once individuals are selected, the user may press button 154 to invite the individuals to join the group.

Alternatively, users may select different entities to follow. Users may follow an entity in different manners. As disclosed above in the previous embodiment, a user when in the setting screen as shown in FIG. 4 may indicate certain entities the user wishes to follows. Alternatively, a user may do a search for a particular entity as disclosed above. The listing of the above is given as examples and should not be seen in a limiting manner.

Once a user becomes a follower of a particular entity, the user has the option to receive notifications when the entity that the user is following have either begun to stream live video or have sent out pre-notifications that they will be streaming at a certain time (such as 3:15 pm PST) or within a certain time (like thirty seconds, or five minute, etc.). The pre-notifications may be a message sent to the inbox of the application as shown in FIG. 10, a text message, an email, or the like. The above listing is given as an example and should not be seen in a limiting manner. Even if a pre-notification is sent, a notification could also be sent when actual streaming starts in a similar manner as described above. The user that is following the entity may have the option of configuring notifications in the Setting screen shown in FIG. 4 of the application to receive certain notifications or not.

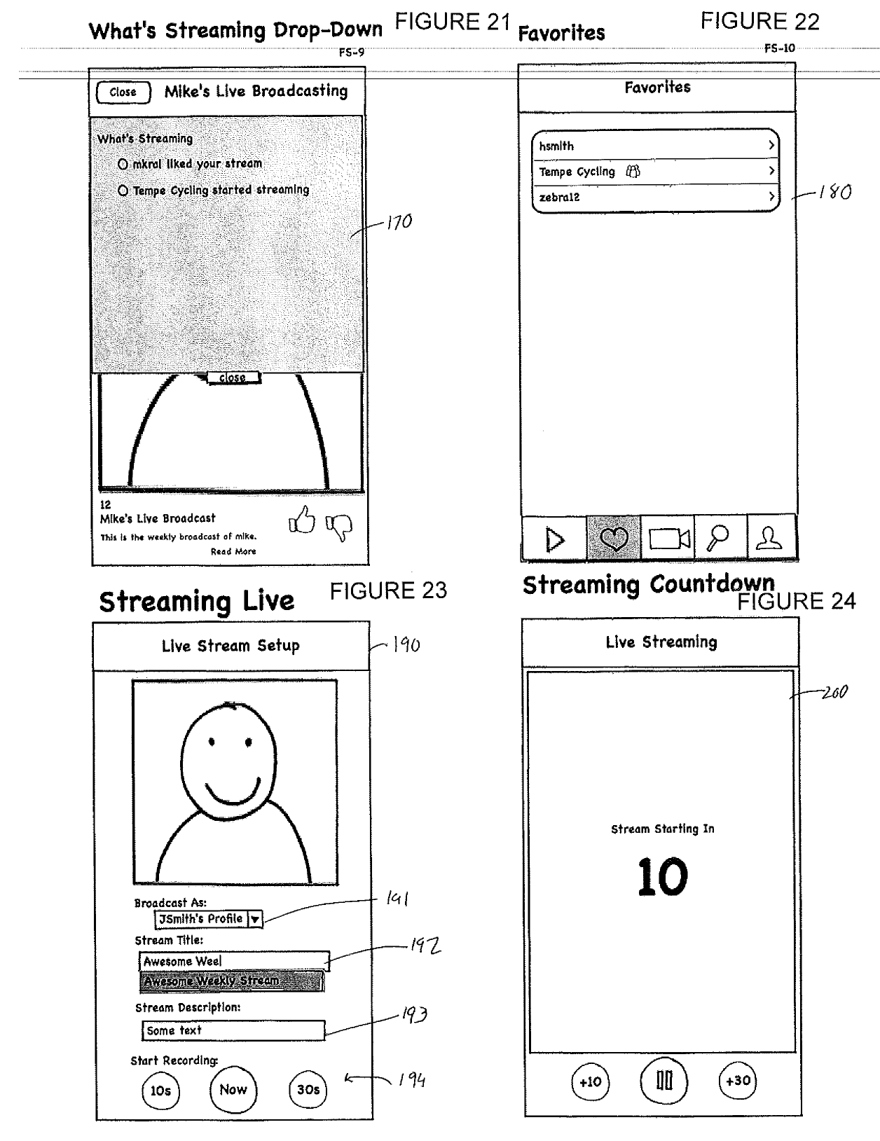

Referring to FIG. 19, if there are multiple entities that a user is following that are streaming at the same time, the user may be presented with a list of the entities and be able to choose or toggle between the live streams including by not limited to a thumbnail view. .In this case, selecting a thumbnail will make the video full screen as shown in FIG. 20. As shown in FIG. 21, a user may rate the video by pressing a Like/Dislike button 160. When other users press the like/dislike button 160, messages 170 may appear on as shown in FIG. 21, When the messages 170 are shown, the video stream generally continues to play. The message 170 may be close by pressing button 171 so that the video stream may be seen.

Messaging and a clickable URI, may also be setup by the entity that will be associated with the live streaming video. For example, messaging could be part of a translucent bar that overlays the video that when clicked or selected by a user navigates the user to the associated URL that was associated with the message.

Entities have the option to charge additional fees to the users that may be following the entity for the ability to view the video streams) of the entity. The application is designed to handle any fee transactions on behalf of the entity and in turn pay the entity a percentage of revenue generated from the users following the entity.

While a user may select numerous groups/entities to follow, the user may select certain favorites as shown in the Favorite Screen 180 in FIG. 22. Users may select and add specific entities/groups as favorites.

Referring to FIG. 23, a Streaming Video Set-Up Screen 190 is shown. In the Streaming Video Set-Up Screen 190 the user may select a profile name 191 as to who the video stream will be broadcast under. The user may further enter a title of the video stream in area 192 and text in area 193 about the video stream. The user may then press a button 194 to indicate when the video should begin recording/transmitting.

Referring to FIG. 24, once a video stream has been selected, if the video stream has not begun, a countdown screen 200 may be shown. The countdown screen 200 may have a predetermined time frame for counting down such as 10 seconds or the like.

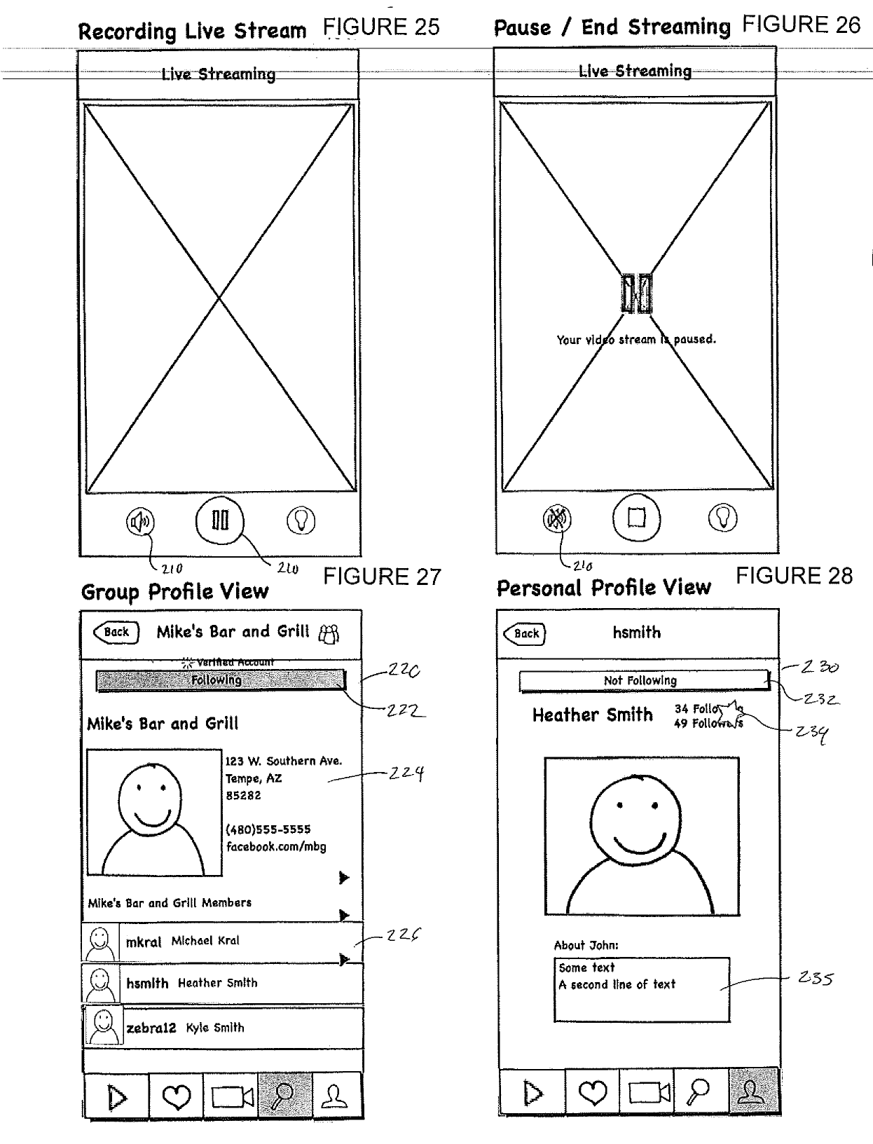

Referring to FIGS. 25-26 show screen shots for recoding (FIG. 25) and pausing (FIG. 26) of the video stream. Buttons 210 may be provided for recording/stopping the video stream, volume control, and the like.

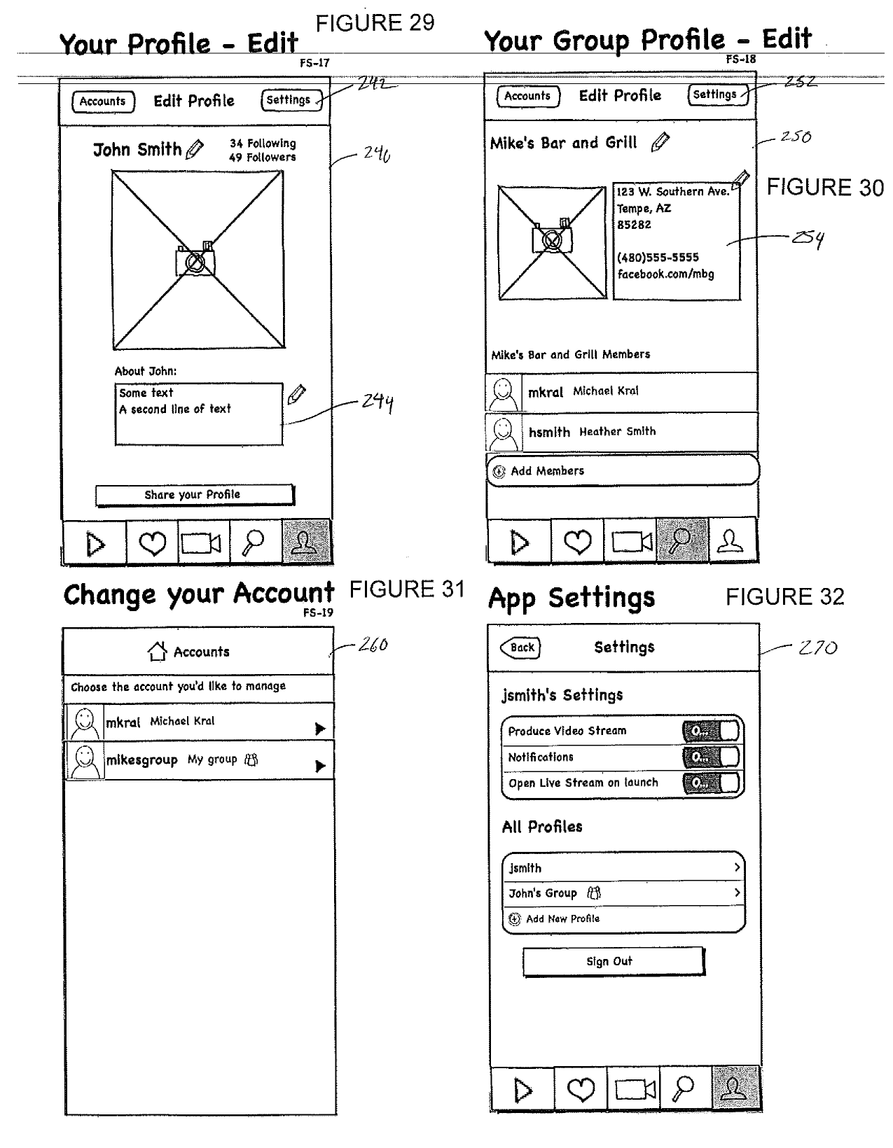

Referring to FIG. 27-28, profile screens 220 and 230 for a Group/Entity (FIG. 29) and an individual (FIG. 30) are shown. The profile screens 240 and 250 may have a button 222 or 232 for following the Group/Entity or individual. The profile screens 220 and 230 may further include an area 224 for showing information about the Group/Entity or individual, an area 226 for followers of the Group/Entity or individual and the like. An area 234 may be provided to show the number of followers. An area 235 may also be provided to send a note to the Group/Entity or individual.

Referring to FIGS. 29-30, edit profile screens 240 and 250 for a Group/Entity (FIG. 30) and an individual (FIG. 29) are shown. Buttons 242, 252 may be provided for viewing settings for the profile screens 240 and 250. Areas 244 and 254 may be provided to edit information of the group/entity or individual.

Referring to FIG. 31, a user or group/entity may have multiple accounts. All accounts may be linked together and shown on an account screen 260. The account screen 260 may allow a user to select which account they would like to currently use and manage.

Referring to FIG. 32, an application setting screen 270. The application setting screen 270 allows one to set-up how to receive notifications, how the streaming videos are launched, and the like. The above listing is given as an example and should not be seen in a limiting manner. The application setting screen 270 may also allow one to select the user's profile.

While embodiments of the disclosure have been described in terms of various specific embodiments, those skilled in the art will recognize that the embodiments of the disclosure may be practiced with modifications within the spirit and scope of the claims.

What is claimed is:

1. A method for requesting and viewing real time data comprising:
selecting an entity to follow by a requesting user;
sending a notification by the entity to the requesting user when said real time data will be sent;
recording said real time data by said entity;
sending said real time data to a host server; and
transmitting said real time data to said requesting user.

2. The method of claim 1, further comprising:
transferring to a display to view said real time date; and
viewing said real time video by said requesting user.

3. The method of claim 1, wherein sending a notification further comprises sending one of an email, a text or the like to said requesting user.

4. The method of claim 1, wherein sending a notification further comprises sending said notification having a time frame of when said real time date is to be posted.

5. The method of claim 1, further comprising providing messaging with said real time date.

6. The method of claim 1, further comprising providing a clickable URL with said real time date.

7. The method of claim 1, further comprising providing a clickable URL with said real time date, wherein said clickable URL provides a message to said requesting user.

8. A computer-implemented method for requesting and viewing real time data comprising:
selecting an entity to follow by a requesting user;
sending a notification by the entity to the requesting user when said real time data will be sent;
recording said real time data by said entity;
sending said real time data to a host server; and
transmitting said real time data to said requesting user.

9. The computer-implemented method of claim 8, further comprising
transferring to a display to view said real time date; and
viewing said real time video by said requesting user.

10. The computer-implemented method of claim 8, wherein sending a notification further comprises sending one of an email, a text or the like to said requesting user.

11. The computer-implemented method of claim 8, wherein sending a notification further comprises sending said notification having a time frame of when said real time date is to be posted.

12. The computer-implemented method of claim 8, further comprising providing messaging with said real time date.

13. The computer-implemented method of claim 8, further comprising providing a clickable URL with said real time date.

14. The computer-implemented method of claim 8, further comprising providing a clickable URL with said real time date, wherein said clickable URL provides a message to said requesting user.

15. A computer-implemented method for requesting and viewing real time data comprising:
selecting an entity to follow by a requesting user;
sending a notification by the entity to the requesting user when said real time data will be sent, wherein sending a notification further comprises sending one of an email, a text or the like to said requesting user;
recording said real time data by said entity;
sending said real time data to a host server;
transmitting said real time data to said requesting user.
transferring said real time data to a display to view said real time date; and
viewing said real time video by said requesting user.

16. The computer-implemented method of claim 15, wherein sending a notification further comprises sending said notification having a time frame of when said real time date is to be posted.

17. The computer-implemented method of claim 15, further comprising providing messaging with said real time date.

18. The computer-implemented method of claim 15, further comprising providing a clickable URL with said real time date.

19. The computer-implemented method of claim 8, further comprising providing a clickable URL with said real time date, wherein said clickable URL provides a message to said requesting user.
